(19) United States
(12) Patent Application Publication
(10) Pub. No.: US 2002/0103798 A1
(43) Pub. Date: Aug. 1, 2002

(54) Adaptive document ranking method based on user behavior

(76) Inventors: Mani S. Abrol, San Jose, CA (US); Brett M. Johnson, Sunnyvale, CA (US)

Correspondence Address: GARY CARY WARE & FREIDENRICH LLP, 1755 EMBARCADERO ROAD, PALO ALTO, CA, 94303-3340, US

(21) Appl. No.: 09/775,715

(22) Filed: Feb. 1, 2001

(51) Int. Cl. G06F 7/00

(52) U.S. Cl. 707/5

(57) ABSTRACT

A user behavior based document ranking system and method permit prior user behavior associated with a document to affect the future ranking of that document. Thus, the ranking system and method in accordance with the invention incorporates user behavior into the document ranking process.

### BACKGROUND OF THE INVENTION

This invention relates generally to a system and method for ranking the relevance of a document located during a search and in particular to a system and method for ranking the relevance of a document based on user behavior.

In most search systems, a user types in a query consisting of one or more terms. The system then returns a list of documents and some text associated with each document. The documents are typically ordered on the ranks obtained from statistical methods based on the number and positions of the keywords in each document. The text provided with each document could be the document title, a summary, first few lines or any other blurb from the document. The user then examines the list and picks the most relevant documents to view. The ranking process does not typically rank the documents based on the user behavior associated with the documents. It is desirable to provide a ranking system and method that incorporates the user's action of picking certain documents to view into the rank of the documents picked in a novel way so that a subsequent search of the same query terms would yield a higher rank for that document.

Thus, it is desirable to provide an adaptive ranking system and method and it is to this end that the present invention is directed.

### SUMMARY OF THE INVENTION

A ranking system and method are provided that incorporates the user's action of picking certain documents to view into the rank of the documents picked. This method could also incorporate other actions of a user, such as picking a product to buy from a list obtained from a search. Thus, a subsequent search of the same query terms would yield a higher rank for the product bought by the user.

Thus, in accordance with the invention, a system and method for user behavior based ranking of a document is provided. The system comprises means for determining a feature vector associated with a document wherein the feature vector comprises certain significant terms appearing in the document and their weights which are based on their frequency statistics, and means for modifying the feature vector for the document based on user actions during a query of the document so that the document is more highly ranked in response to the user actions.

In accordance with another aspect of the invention, a system and method for user behavior based searching of a document based on a query having one or more query terms is provided. The system comprises a method of ranking documents in a search wherein the rank of a document to one or more search terms is determined from the feature vector of the document. Since the feature vector of a document is adapted in response to users actions, documents get ranked higher in subsequent searches of the same query terms.

### BRIEF DESCRIPTION OF THE DRAWINGS

FIG. 1 is a diagram illustrating a typical web-based search system that may include the user behavior ranking system in accordance with the invention;

FIG. 2 is a diagram illustrating more details of a search engine in accordance with the invention incorporating the user behavior ranking system;

FIG. 3 is a flowchart of a typical search method;

FIG. 4 is a flowchart illustrating a typical method for calculating a document rank;

FIG. 5 is a flowchart illustrating a typical method for retrieving search results based on feature vectors of documents; and

FIG. 6 is a flowchart illustrating more details of how the feature vectors of documents are updated after capturing user behavior in accordance with the invention.

### DETAILED DESCRIPTION OF A PREFERRED EMBODIMENT

The invention is particularly applicable to a web based search system and it is in this context that the invention will be described. It will be appreciated, however, that the ranking system and method in accordance with the invention has greater utility, such as to other types of search systems that are implemented on other different computer systems and other types of search systems that permit other items, such as documents and the like, to be searched.

FIG. 1 is a diagram illustrating a typical web-based search system 20 that may include the user behavior ranking system in accordance with the invention. The search system may include a search server computer 22 that is connected by a computer network 24, such as a local area network, a wide area network or preferably the Internet or the World Wide Web, to one or more web sites 26 (WS₁, WS₂, . . . , WSₙ) wherein each web site contain one or more web pages that may be searched using the search server computer. For purposes of this description, each web page associated with a web site may be a document that may be searched by the user. As is well known, a user of a computer 28 (there may actually be one or more computers that execute a browser application to submit queries to the search system) may connect to the search server 22 over the computer network 24 and submit a search query to the search server using a typical protocol, such as HTTP. The search query may include one or more query terms. The search server may retrieve web pages that match those query terms, rank the web pages and return a list of ranked web pages that the user may browse through and select a web page from the list. In accordance with the invention, the user's behavior when he/she receives the ranked list of web pages may be used to change the ranking of the documents during subsequent searches for the same query terms as described below in more detail.

The server computer 22 may include one or more central processing units (CPU) that control the operation of the computer, a persistent storage device 32, such as a hard disk drive, a tape drive, an optical drive of the like, that maintains data even when the power is turned off to the computer and a temporary memory 34, such as DRAM, whose contents are lost when the power is turned off to the computer. As is well known, one or more pieces of software are permanently stored in the persistent storage device 32 and then a particular software application is loaded into the memory 34 when the CPU is executing the particular software application. In the example shown, a search engine software application 36 may be loaded into the memory 34 to perform the operations associated with the search system.

The user computer 28 may include a display device 40, such as a CRT or a LCD, that permits the user to interact with the computer, a chassis 42 and one or more input/output devices that permit the user to interact with the computer and the software being executed by the computer, such as a keyboard 44 and a mouse 46. The chassis 42 may include a central processing unit 48 that controls the operation of the computer, a persistent storage device 50 as described above and a memory 52 as described above. To access the search system over the computer network, to submit a query and to receive a list of ranked documents, the computer 28 may be executing a browser software application 54 that permits the user to interact with the search system using a typical protocol, such as HTTP. In the web-based example shown, the user may be presented with a graphical form to fill in one or more query terms and submit to the server and the server may return a graphical page containing a listing of one or more ranked web pages that the user may select. When the user selects a web page from the list, the user is connected to the web page. Now, the search engine on the server will be described in more detail.

FIG. 2 is a diagram illustrating more details of the search engine 36 in accordance with the invention incorporating the user behavior ranking system. The search engine may include one or more pieces of software that provide the functionality of the search engine to the user. In particular, the search engine 36 may receive a query containing one or more query terms. The query may be fed into a document matcher 60 that locates documents/web pages in a document/web page index 62 that match the query terms in the query from the user. The documents/web pages that match the query terms may then be fed into a document ranker 64 that ranks the documents based on user behavior as described below in more detail. The search engine then outputs a list of ranked documents that are displayed to the user. In accordance with the invention, the prior user behavior during the review of the documents by the user may be used to rank the documents retrieved during future searches as described below in more detail. To better understand the user behavior ranking in accordance with the invention, a typical search method will be briefly described.

FIG. 3 is a flowchart of a typical search method 70. In a first step 72, the server may receive a query from a user containing one or more query terms. In step 74, the search engine may retrieve one or more documents that match the query terms. In step 76, the search engine may rank the document in some manner and then present a list of ranked document to the user in step 78. The reason for the ranked documents is that the search method attempts to rank the documents so that the most relevant documents appear first so that the user may find the most relevant document more rapidly. There are many different ranking techniques that may be used. Now, a method for ranking the documents based on user behavior will now be described in more detail.

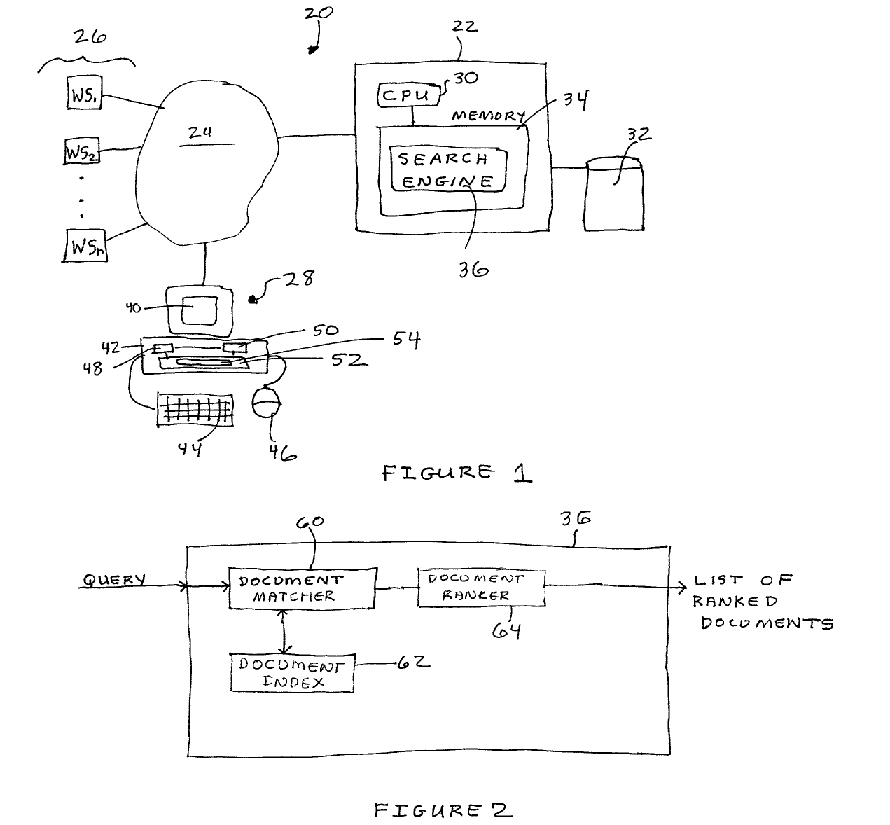

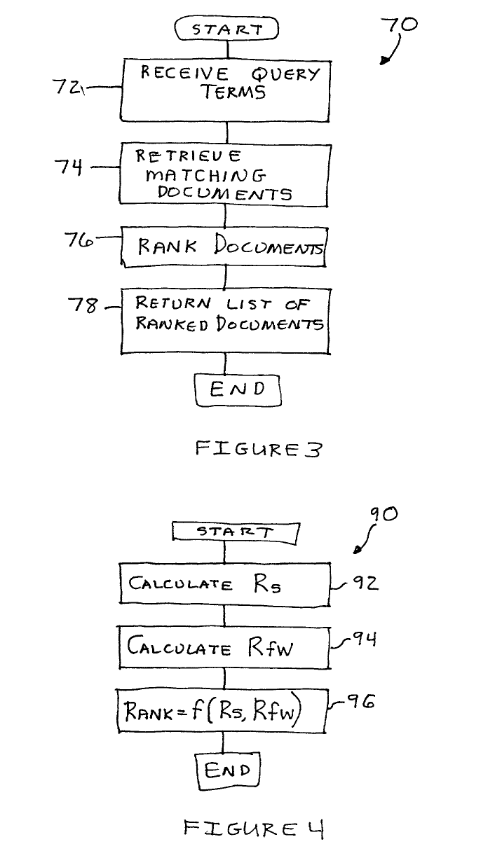

FIG. 4 is a flowchart illustrating a user behavior ranking method 90 in accordance with the invention wherein each document may be ranked according to the method. The proposed user behavior ranking method is based on two factors. In step 92, Rₛ is determined for each document wherein Rₛ is obtained from typical statistical calculations dependent on the number and positions of the keywords in each document as is well known. See Ian H. Witten, Alistair Moffat and Timothy C. Bell. Managing Gigabytes. Van Nostrand Reinhold, New York, 1994 for a summary of these typical statistical methods that may be used to calculate Rₛ. In step 94, R_{fW} is calculated as a distance measure of the query to the feature vector of the document. In particular, certain words and phrases of a document are selected during a feature selection process to form this feature vector. See Yang, Y., Pedersen, J. O., A Comparative Study on Feature Selection in Text Categorization, Proc. of the 14th International Conference on Machine Learning ICML97, pp. 412-420, 1997 for a comparative study of different feature selection methods. In accordance with the invention, the R_{fW} value may be changed based on user behavior as described below in more detail. Using these two values/variables, the rank of the document may be calculated as the Rank wherein Rank=ƒ(Rₛ, R_{fw}). Now, more details of the user behavior ranking method in accordance with the invention will be described.

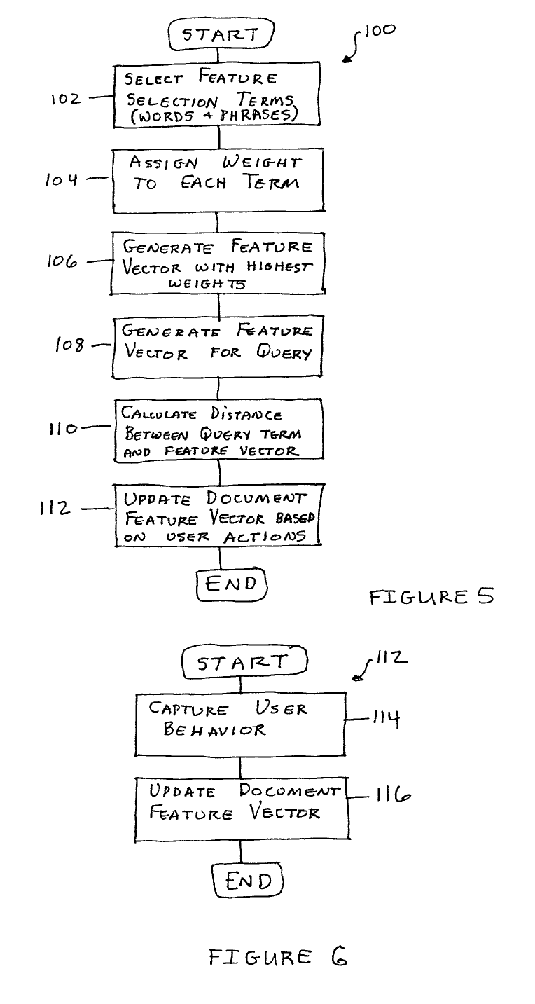

FIG. 5 is a flowchart illustrating more details of the user behavior ranking method and in particular a method 100 for calculating the user behavior-based feature vector in accordance with the invention. In particular, in step 102, certain words and phrases of a document are selected through a well known feature selection process to form a feature vector. The article cited above provides an overview of different feature selection methods. Each term is then assigned a weight wᵢ in step 104 that is calculated from statistical methods based on the term frequency. After calculating the weights of the terms, the number of terms, j, with the highest weights are selected for the feature vector representation of the document in step 106. The feature vector holds a space for each term in the entire corpus of documents so that most feature vectors will be sparse in that few of the spaces in each feature vector will be filled with information. The feature vector is denoted as F=<wᵢ> where wᵢ represents the weight of the ith term in document F.

A query, Q, having n terms can also be represented as a feature vector in step 108 in which each element is a keyword in the query so that Q=<wᵢⱼ>. In step 110, R_{fw} is then calculated as a distance measure of the query term to the feature vector of the document. An example of the distance measure is the cosine or normalized inner product. The weights are normalized at time of feature selection so that R_{fw}=ƒ(Fᵢ, Q)=Σwᵢₖ*wⱼₖ; k=1 to k=t, where t is the total number of terms in the corpus, wᵢₖ is the weight of the k th term in the document feature vector Fᵢ, and wⱼₖ is the weight of the k'th term in the query feature vector Q. See Salton, G., Wong, A. and Yang, S. S., ‘A vector space model for automatic indexing’, Communications of the ACM, 18, 613-620 (1975) for more details on feature vector representation and similarity measures. In step 112, the feature vector for any document may be updated so that, for future queries with the same query terms, a document may be more highly ranked or less highly ranked based on the user behavior as will now be described.

FIG. 6 is a flowchart illustrating more details of the user behavior ranking step 112 in accordance with the invention. In particular, in step 114, users' behavior is monitored and sequences of search queries and documents picked on each search are captured over time. In accordance with the invention, not all user interactions are logged since only carefully chosen samples are taken at certain intervals. Thus, the queries are sampled at a frequency ƒₛ, which is small enough so that the system response time does not degrade and large enough to capture enough information from users' behavior. Each sample consists of a query, Q, and a set of documents viewed from the result list whose feature vectors are F₁, F₂, . . . Fₙ. Then, in step 116, for each Fᵢ in the set of documents F₁, F₂, . . . Fₙ, the feature vector is updated by an update function U() to F_{i updated}=U(Fᵢ, Q). After this update to the feature vector, all subsequent queries containing the terms of the query Q would yield higher ranks for the documents represented by F₁, F₂, . . . Fₙ.

Now, preferred embodiments for choosing the weights wᵢ of the terms in the feature vector, the ranking function ƒ(), the sampling frequency ƒₛ, and the feature vector update function U() are provided.

1. The weight wᵢ is preferably chosen to be the TF×IDF value of the term which is calculated from the Term Frequency and the Inverted Document Frequency. Salton, G., and C. Burkley. Term-Weighting Approaches in Automatic Text Retrieval. Information Processing and Management, 24(5), pages 513-523, 1988 provide a good description of this well known calculation.

2. The Ranking function, ƒ(), depends on the statistical rank calculation Rₛ and the vector distance measure R_{fw}. Examples of this function may include:

ƒ(Rₛ, R_{fw})=αRₛ+(1−α)R_{fw} such that 0<=α<=1

ƒ(Rₛ, R_{fw})=Rₛ/R_{fw}

3. The sampling frequency, ƒₛ, could be determined by one of the following:

A Simple Random Sampling technique can be implemented such that a small subset, say 1% of all user searches are monitored.

A systematic random sampling technique could be used. A starting point is chosen, possibly at random and thereafter a sample is picked at a regular interval, for example every 1000^{th} search may be chosen.

4. The Feature vector update function is such that it makes the document come closer to the query in the vector space. A preferred embodiment is

U(Fᵢ, Q)=Fᵢ+ξQ

where ξ could be chosen to be any of the following

0<ξ<=1 and is constant for all updates.

ξ is directly proportional to the time spent by the user viewing the document represented by Fᵢ after issuing the query Q except in cases when the viewing time is extremely small or large. Small viewing times could be indications of negative feedback so in that case ξ is negative and extremely large viewing times are not indicative of relevancy ξ is constant in those cases.

In certain systems users are prompted to rate an article on degree of usefulness and relevancy, in these situations ξ is proportional to that rating.

To better understand the invention, an example of how a feature vector for a document may be modified by user behavior in accordance with the invention will be provided for illustration purposes only. Thus, consider two documents whose feature vector representations are:

D1=<dog 0.43; cat 0.26; fleas 0.15; collar 0.11, feed 0.09 . . . > and

D2=<pet 0.36; food 0.26; cat 0.12 . . . >

wherein the frequency of each term in each document is represented by the feature vector. When a user issues a query “cat dog food”, the system may return the above two documents, D1 and D2, with initial ranks of 0.85 and 0.79 respectively due to the above feature vectors. In particular, the rank calculation is an inner cosine distance of the two vectors. In this case the query vector would be: Q=<0.33 cat; 0.33 dog; 0.3 food> so the distance between D1 and Q is (multiply the weights of the common terms) Rd1=0.43*0.33+0.26*0.33=0.85 and the distance between D2 and Q is Rd2=0.26*0.33+0.12*0.33=0.79.

In the result list, the user is presented with the title of these documents and the user picks document D2 to view in more detail. Assuming that this particular search was sampled to update the feature vector, the feature vector of D2 would get modified to D2=<pet 0.36; food 0.31; cat 0.19, dog 0.05 . . . > wherein the weighting for each term in the feature vector that is also in the query is increased to reflect that the user selected document D2 during a prior search. In the future, during any subsequent query containing the same query terms “cat dog food”, document D2 is ranked with a higher score due to the updating. Thus, in this example, if the same query is done again, document D2 will get a 0.86 score which is higher than the score for document D1. Thus, document D2 will appear higher in the result list during the subsequent search due to the user behavior updating.

Thus, in accordance with the invention, the rank of a document and therefore its location in the returned list of ranked documents may be altered due to the prior user behavior. Thus, the user behavior ranking system and method in accordance with the invention may take the acts of prior users into account when returning the list of ranked documents to the user. Thus, user behavior ranking in accordance with the invention may permit the documents at the top of the list returned to the user to be more relevant and to be influenced by a user's actions with respect to the returned documents. For example, a document may appear to be very relevant based on its title, etc, but a user may then view the document which will affect the ranking of the document. As another example, a document may not appear to be very relevant based on its title, but many prior users may view the document so that the document may appear closer to the top of the ranked document list that it would in a more typical document ranking system. As yet another example, a user searched for Palm products, but actually bought a Handspring product which was listed on the second page of the search results. Accordingly, the feature vector of the Handspring product is updated. Then, when another user searches for “Palm”, they will see the Handspring document listed higher in the search results. In accordance with the invention, the length that a user views a document may also affect the ranking of the document.

While the foregoing has been with reference to a particular embodiment of the invention, it will be appreciated by those skilled in the art that changes in this embodiment may be made without departing from the principles and spirit of the invention, the scope of which is defined by the appended claims.

1. A system for user behavior based ranking of a document, comprising:
means for determining a feature vector associated with a document, the feature vector comprising weights for certain terms that appear in the document; and
means for modifying the feature vector for the document based on user actions during a search session so that the document is more highly ranked in response to the user actions.

2. The system of claim 1 further comprising means for collecting user actions in response to a list of documents produced in response to a query wherein the user actions include selecting a document from the list of documents.

3. The system of claim 2 further comprises means for adjusting the weights of the terms in the feature vector that match terms in a query that produced the list of documents so that the ranking of the document is higher in response to the adjustment of the weights.

4. A method for user behavior based ranking of a document, comprising:
determining a feature vector associated with a document, the feature vector comprising weights for one or more terms that appear in the document; and
modifying the feature vector for the document based on user actions during a query of the document so that the document is more highly ranked in response to the user actions.

5. The method of claim 4 further comprising means for collecting user actions in response to a list of documents produced in response to a query wherein the user actions include selecting a document from the list of documents.

6. The method of claim 5, wherein the modifying means further comprises means for adjusting the frequency values of the terms in the feature vector that match terms in a query that produced the list of documents so that the ranking of the document is higher in response to the adjustment of the frequency values.

7. A system for user behavior based searching of a document based on a query having one or more query terms, comprising:
means for determining a feature vector associated with a document, the feature vector comprising weights for certain terms that appear in the document;
means for modifying the feature vector for the document based on user actions during a query of the document so that the document is more highly ranked in response to the user actions; and
means for returning the same document to another user with the same query at a higher ranking due to the modified feature vector.

8. The system of claim 7 further comprising means for collecting user actions in response to a list of documents produced in response to a query wherein the user actions include selecting a document from the list of documents.

9. The system of claim 8, wherein the modifying means further comprises means for adjusting the frequency values of the terms in the feature vector that match terms in a query that produced the list of documents so that the ranking of the document is higher in response to the adjustment of the frequency values.

10. A method for user behavior based searching of a document based on a query having one or more query terms, comprising:
determining a feature vector associated with a document, the feature vector comprising frequency values for one or more terms that appear in the document;
modifying the feature vector for the document based on user actions during a query of the document so that the document is more highly ranked in response to the user actions; and
returning the same document to another user with the same query at a higher ranking due to the modified feature vector.

11. The method of claim 10 further comprising means for collecting user actions in response to a list of documents produced in response to a query wherein the user actions include selecting a document from the list of documents.

12. The method of claim 11, wherein the modifying means further comprises means for adjusting the frequency values of the terms in the feature vector that match terms in a query that produced the list of documents so that the ranking of the document is higher in response to the adjustment of the frequency values.
